(19) United States
(12) Patent Application Publication
(10) Pub. No.: US 2026/0368611 A1
(43) Pub. Date: Nov. 19, 2026

(54) TRAINING A SPECTRUM INFERENCE MODEL

(71) Applicant: International Business Machines Corporation, Armonk, NY (US)

(72) Inventors: Hajime Shinohara, Yokohama (JP); AKIHIRO KISHIMOTO, Tokyo (JP)

(21) Appl. No.: 18/643,187

(22) Filed: Apr. 23, 2024

(51) Int. Cl. G06N 20/00

(52) U.S. Cl. CPC G06N 20/00

(57) ABSTRACT

Training a spectrum inferencing machine learning model by: receiving a training dataset which contains molecular descriptions including spectrum data, determining, shape parameters of the spectrum data, training the machine learning model using the training dataset and minimizing a loss function associated with the shape parameters; and providing the trained model for inferring unknown spectra.

### FIELD OF THE INVENTION

The disclosure relates generally to training a machine learning model for generating spectrum data. The invention relates particularly to training a machine learning model for generating inferred ultraviolet spectra data.

### BACKGROUND

Ultraviolet (UV) absorption spectrum data can provide a latent representation of molecular structures and may further be used in predicting molecular properties and/or generating structures associated with desired molecular properties.

UV absorption spectral data sets tend to be sparse. Additionally, the shape of molecular UV absorption spectra tends to be difficult to infer due to relatively mild curves of the spectral data and the sparse data sets available for known molecular structures.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the generation of inferred UV spectral data and the training of machine learning models using such data.

Aspects of the invention disclose methods, systems and computer readable media associated with training a spectrum inferencing machine learning model by: receiving a training dataset which contains molecule descriptions including spectrum data, determining, shape parameters of the spectrum data, training the machine learning model using the training dataset and minimizing a loss function associated with the shape parameters; and providing, by the one or more computer processors, the trained model for inferring unknown spectra.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Though UV spectral data provide a latent representation of molecular structure, and may further provide an indication of molecular properties, the limited availability of spectral data in combination with other molecular data reduces the effectiveness of using such data in training a machine learning model for studying molecular structures, or inferring structures associated with desired properties. Inferring UV spectral data can be considered as a sequencing problem, where the next value in a sequence must be determined or inferred from previous values in view of other associated parameters of a given system or environment. Disclosed embodiments provide methods, systems, and computer program products enabling the inferencing of UV spectral details and the training of machine learning models using such inferred spectral data.

Aspects of the present invention relate generally to inferring spectral data from sparse molecular data sets, thereby enabling the training of machine learning models using the inferred spectral data, including UV spectral data for molecular structures of interest. Such aspects include training a spectrum inferencing machine learning model by: receiving a training dataset which contains molecule descriptions including spectrum data, determining, shape parameters of the spectrum data, training the machine learning model using the training dataset and minimizing a loss function associated with the shape parameters; and providing, by the one or more computer processors, the trained model for inferring unknown spectra.

In accordance with aspects of the invention there is a method for automatically inferring UV spectral data from received molecular data, the method comprising: receiving a training dataset which contains molecule descriptions including spectrum data, determining, shape parameters of the spectrum data, training the machine learning model using the training dataset and minimizing a loss function associated with the shape parameters; and providing, by the one or more computer processors, the trained model for inferring unknown spectra.

Aspects of the invention provide an improvement in the technical field of machine learning models for molecular analysis. Conventional molecular analysis models rely upon training data sets including sparse amounts of UV spectral data, and spectral data lacking fine details. In some cases, spectral data for molecular structures of interest is unavailable. As a result, the machine learning models base inferences associating molecular structures and molecular properties upon other latent relationships and may not produce satisfactory results. By generating fine resolution UV spectral data, embodiments of the invention enable the training of machine learning models which associate molecular structures and molecular properties using the latent representations of the molecular structures embodied in the generated UV spectral data. This provides the improvement of achieving a desired outcome for the user (i.e., providing models capable of identifying molecular properties associated with posited structures as well as identifying molecular structures associated with posited sets of molecular properties.

Aspects of the invention also provide an improvement to computer functionality. Implementations of the invention are directed to a specific improvement to the training of machine learning models for studying molecular structures and properties, embodied in the expansion and refinement of molecular UV spectral data. In embodiments, the system receives a data set including molecular information including spectral data. The system determines shape parameters, such as second derivatives, for the spectra data of the received data set. The system analyzes the shape parameters, determining statistical parameters for the shape parameter data, and modifies a loss function to include a penalty term associated with the statistical parameters of the shape parameters of the training data spectral information. The system refines the training data set using the modified loss function as a result of modifying the loss function according to the statistical parameters of the spectral data, disclosed systems and methods yield a refined training data set associated with spectral data satisfying pre-defined statistical thresholds. This refined training data set may then be utilized in the training of additional molecular analysis machine learning models, overcoming the deficiencies represented by the initially sparse training data set and increasing the likelihood that a useful machine learning molecular analysis model may be provided.

As an overview, a machine learning system is an artificial intelligence application executed on data processing hardware that answers questions pertaining to a given subject-matter. The trained machine learning system receives inputs and infers outputs according to the training of the machine learning model. In disclosed embodiment, machine learning models are trained to infer molecular properties when provided with molecular structure input data or to infer molecular structures when provided with molecular property input data. Provided with an initial set of training data including molecular spectra data, embodiments infer additional spectral data based upon an analysis of the provided training spectral data. The inferred spectral data then serves as a training data set for an additional model, overcoming a deficiency of spectral data for molecular structures and/or properties of interest.

In an embodiment, one or more components of the system can employ hardware and/or software to solve problems that are highly technical in nature (e.g., determining shape parameters for received spectral data, training a machine learning model using received data and a loss function minimized according to the determined shape parameters of the received data, etc.). These solutions are not abstract and cannot be performed as a set of mental acts by a human due to the processing capabilities needed to facilitate machine learning model training, for example. Further, some of the processes performed may be performed by a specialized computer for carrying out defined tasks related to the generation and use of machine learning model training data sets. For example, a specialized computer can be employed to carry out tasks related to generating training data and utilizing that data for training a machine learning molecular analysis model, or the like.

In one embodiment, systems and methods receive training data including molecular properties such as molecular structure data, molecular functional attributes, and molecular physical properties, including molecular UV absorption spectrum data, for collections of molecules. UV spectral data includes the level of UV absorption for a range of UV frequencies. Such UV spectral data may be depicted as a curve having an x-axis of frequency and a y-axis of absorption for each available frequency for each molecule. In one embodiment, the method receives Simplified molecular-input line-entry system (SMILES) data including the molecular data.

In one embodiment, methods analyze the received spectral data by determining the shape parameters, the first and second derivatives of the curve representing the absorption data. Second derivatives provide additional information regarding the shapes of distributions of the spectral data. In one embodiment, methods perform statistical analysis on the second derivatives of the data, determining the statistical parameters of the set of second derivatives. In one embodiment, statistical analysis applications, such as PANDAS, SCIPY, or SKLEARN may be used to determine the mean, median, and standard deviation, among other statistical parameters, for the distribution of the second derivatives of the spectral data from the training data set. (Note: the terms: SMILES, PANDAS, SCIPY, and SKLEARN, may be subject to trademark rights in various jurisdictions throughout the world and are used here only in reference to the products or services properly denominated by the marks to the extent that such trademark rights may exist.).

In one embodiment, after determining the statistical parameters of the shape parameters/second derivatives of the spectral data of the training data set, methods modify the loss function used for training a machine learning model. The loss function may comprise a root-mean-square error (RMSE) loss function utilized in a gradient descent calculation for determining network node weights, for a network such as a fully connected neural network unit (FCU), long-short term memory model, or other recurrent neural network model architecture. In this embodiment, methods add a penalty term to the RMSE loss function, thereby reducing the contribution of spectral data having values exceeding a pre-defined threshold. As an example, the additional penalty term of the modified loss function reduces the contribution of spectral data more than three standards deviations from the mean of the set of spectral data (more than 3-sigma). In other embodiments, other penalty thresholds, such as 1-sigma, 2-sigma, or other values may be used for the penalty term threshold. In one embodiment, the loss function comprises the RMSE for second derivative values within plus or minus three sigma od the mean, for second derivative values more than plus or minus three sigma from the mean, the loss function comprises the RMSE plus the penalty term, such as Penalty=|x−3σ|2. Calculating the node weights of the network nodes while minimizing the value of the modified loss function accentuates the contribution of more finely detailed spectral data to the node weights and the model outputs and reduces the contribution of more coarsely distributed spectral data to the node weights and model outputs. The resulting trained machine learning model may then be utilized for the generation of unknown molecular spectral data taking molecular structures or molecular properties as input data. In one embodiment, methods provide trained model for use in molecular discovery, and molecular analysis efforts.

In one embodiment, methods proceed by refining the received spectrum data. In this embodiment, methods remove spectrum data from the training data wherein the second derivative of the spectrum data fails to satisfy a pre-defined threshold associated with the statistical parameters of the second derivatives of the entire original spectrum data of the training data set. As an example, methods determine the second derivatives of the entire training data set of spectral data. Method then analyze the distribution of the values of the second derivative, determining the mean and standard deviations for the distribution of second derivative values. Methods then define thresholds for inclusion of data in the training dataset based upon the statistical analysis, such as a threshold of plus or minus three standard deviations from the mean. In this example, methods exclude all spectral data having a second derivative more than three standard deviations from the mean for the distribution and include only the spectral data having second derivative values less than three standard deviations from the mean in the training data set. Methods then train machine learning models using the refined training data set, gradient descent, and the minimization of a loss function.

In one embodiment, an initial training dataset includes data for 3,170 molecules. Methods divide this initial set into a training data set, 80%, or 2,536 molecules, a verification set, 10% or 317 molecules, and a testing set, 10% or 317 molecules. Methods trained models using the original training data set and a loss function without a second derivative threshold penalty term, and also trained models using the training data set together with a loss function refined by the addition of a penalty term defined according to the mean and standard deviation of the second derivative data of the original training data set. Models were then optimized using the validation data to adjust model hyperparameters. Exemplary model hyperparameters include learning rate, batch size, number of epochs, weight decay and node drop out parameters. Methods then tested the models using the test datasets. For this example, Table 1 provides the resulting loss function values for the original and refined training data sets after one thousand epochs. The data of Table 1 illustrate that embodiment of the invention, by refining the training dataset and loss function according to an imposed threshold on the acceptable values of spectral data second derivatives, reduce the loss function value at one thousand epochs, indicating an improvement in model accuracy.

TABLE 1

| Second derivative threshold | FCU | LSTM |
|---|---|---|
| No limit | 0.1624 | 0.1727 |
| 3 sigma | 0.1562 | 0.1617 |

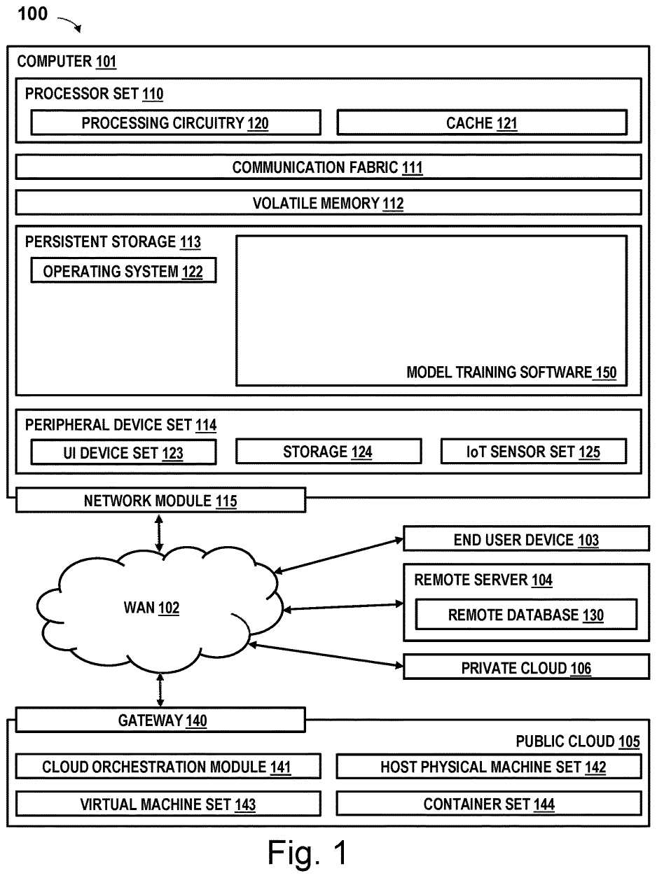

As shown in FIG. 1, computing environment 100 contains an example of an environment for the execution of at least some of the computer code involved in performing the inventive methods, such as model training software block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

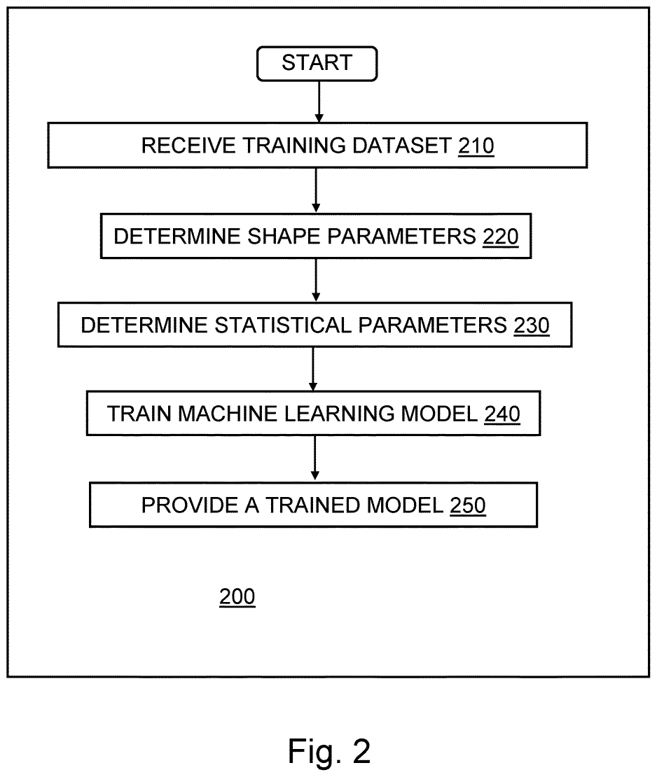

FIG. 2 provides a flowchart 200, illustrating exemplary activities associated with the practice of the disclosure. After program start, at block 210, methods receive training a data set. Such training data sets include molecular data such as UV spectrum data for individual molecular structure. In one embodiment, received training data include SMILES data.

At block 220, methods analyze the training set spectral data, determining shape parameters, such as second derivative values, for the spectral data of the training dataset.

At block 230, methods analyze the shape parameter data determined from the spectral data. In one embodiment, methods use statistical analysis software, such as PANDA, SCIPY, or SKLEARN, to analyze the shape parameter data. In this embodiment, methods determine statistical values including mean and standard deviation values for the shape parameter value distributions.

At block 240, methods train a machine learning model using the training dataset, gradient descent, and a loss function which includes a penalty term associated with the statistical parameter distribution for the second derivative values. In embodiments, methods train a FCU or LSTM model using the training dataset and loss function.

At block 250, methods provide the trained machine learning model for use in molecular structural analysis or molecule discovery efforts.

It is to be understood that although this disclosure includes a description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, or media, as those terms are used in the present disclosure, explicitly excludes storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage medium or device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for training a spectrum inferencing machine learning model, comprising:
receiving, by one or more computer processors, a training dataset which contains molecular descriptions including spectrum data,
determining, by the one or more computer processors, shape parameters of the spectrum data,
training, by the one or more computer processors, the machine learning model using the training dataset and minimizing a loss function associated with the shape parameters; and
providing, by the one or more computer processors, the trained model for inferring unknown spectra.

2. The method of claim 1, wherein the loss function includes a penalty term associated with a pre-determined threshold for the shape parameters.

3. The method according to claim 1, further comprising:
determining, by the one or more computer processors, statistical parameters for a set of shape parameters of the spectrum data; and
associating, by the one or more computer processors, the loss function with the statistical parameters.

4. The method of claim 1, wherein the spectrum data comprises a first distribution of UV spectrum data, the method further comprising:
refining the spectrum data using the loss function; and
training the machine learning model suing the refined spectrum data.

5. The method according to claim 1, wherein the model comprises a fully connected neural network unit architecture.

6. The method according to claim 1, wherein the spectrum data comprises UV spectrum data.

7. The method according to claim 1, wherein the loss function comprises a root mean square error regression function.

8. A computer program product for training a spectrum inferencing machine learning model, the computer program product comprising one or more computer readable storage media and collectively stored program instructions on the one or more computer readable storage media, the stored program instructions which, when executed, cause one or more computer systems to perform a method comprising:
receiving a training dataset which contains molecular descriptions including spectrum data,
determining shape parameters of the spectrum data,
training the machine learning model using the training dataset and minimizing a loss function associated with the shape parameters; and
providing the trained model for inferring unknown spectra.

9. The computer program product according to claim 8, wherein the loss function includes a penalty term associated with a pre-determined threshold for the shape parameters.

10. The computer program product according to claim 8, the method further comprising:
determining, by the one or more computer processors, statistical parameters for a set of shape parameters of the spectrum data; and
associating, by the one or more computer processors, the loss function with the statistical parameters.

11. The computer program product according to claim 8, wherein the spectrum data comprises a first distribution of UV spectrum data, the method further comprising:
refining the spectrum data using the loss function; and
training the machine learning model suing the refined spectrum data.

12. The computer program product according to claim 8, wherein the model comprises a fully connected neural network unit architecture.

13. The computer program product according to claim 8, wherein the spectrum data comprises UV spectrum data.

14. The computer program product according to claim 8, wherein the loss function comprises a root mean square error regression function.

15. A computer system for training a spectrum inferencing machine learning model, the computer system comprising:
one or more computer processors;
one or more computer readable storage media; and
stored program instructions on the one or more computer readable storage media for execution by the one or more computer processors, the stored program instructions which, when executed, cause the one or more computer processors to perform a method comprising:
receiving a training dataset which contains molecular descriptions including spectrum data,
determining shape parameters of the spectrum data,
training the machine learning model using the training dataset and minimizing a loss function associated with the shape parameters; and
providing the trained model for inferring unknown spectra.

16. The computer system according to claim 15, wherein the loss function includes a penalty term associated with a pre-determined threshold for the shape parameters.

17. The computer system according to claim 15, the method further comprising:
determining, by the one or more computer processors, statistical parameters for a set of shape parameters of the spectrum data; and
associating, by the one or more computer processors, the loss function with the statistical parameters.

18. The computer system according to claim 15, wherein the spectrum data comprises a first distribution of UV spectrum data, the method further comprising:
refining the spectrum data using the loss function; and
training the machine learning model suing the refined spectrum data.

19. The computer system according to claim 15, wherein the model comprises a fully connected neural network unit architecture.

20. The computer system according to claim 15, wherein the spectrum data comprises UV spectrum data.
